(19) United States
(12) Patent Application Publication
(10) Pub. No.: US 2005/0266132 A1
(43) Pub. Date: Dec. 1, 2005

(54) Supercritical carbon dioxide extraction of carotenoids from natural materials using a continuous co-solvent

(76) Inventors: Feral Temelli, Edmonton (CA); Mei Sun, Edmonton (CA)

Correspondence Address: GARDNER GROFF, P.C., 2018 POWERS FERRY ROAD, SUITE 800, ATLANTA, GA, 30339, US

(21) Appl. No.: 11/141,785

(22) Filed: May 31, 2005

Related U.S. Application Data
(60) Provisional application No. 60/575,380, filed on Jun. 1, 2004.

(51) Int. Cl. A23L 1/27

(52) U.S. Cl. 426/478

(57) ABSTRACT

A method for separating carotenoids from carotenoid-containing material comprising sizing a carotenoid-containing material, passing a mixture of oil and supercritical CO₂ (SC—CO₂) continuously through the carotenoid-containing material at conditions effective to extract a carotenoid into the mixture of oil and SC—CO₂, and collecting the carotenoid-containing oil. Disclosed is a composition made by a method of the invention.

### CROSS REFERENCE TO RELATED APPLICATIONS

This application claims priority to U.S. Provisional application Ser. No. 60/575,380, filed May 31, 2004, hereby incorporated by reference in its entirety for all of its teachings.

1. Technical Field

This invention relates to the field of extraction of carotenoids from carotenoid-containing material, in particular natural materials, such as plant materials and marine algae.

2. Background

Carotenoids such as beta-carotene, lycopene and astaxanthin are receiving increasing attention as natural antioxidants with health benefits, especially in the rapidly growing functional food and nutraceutical market.

The majority of the existing natural carotenoid products on the market are extracted by using organic solvents. Extraction of such nutraceuticals using supercritical carbon dioxide (SC—CO₂) is also growing at a rapid pace since this technique eliminates the use of organic solvents and the products can be labeled as “natural” for marketing purposes. Supercritical CO₂ is CO₂ at temperature and pressure conditions above its critical point, which is the temperature and pressure above which a liquid state cannot exist. For carbon dioxide this is 31° C. and 7.4 MPa. Under these conditions, CO₂ acts like a solvent. Thus, an extraction can be carried out under supercritical conditions and the extract can be recovered with no solvent residue upon depressurization since CO₂ separates as gas.

The extraction of carotenoids from natural materials using SC—CO₂ has been reported, but the solubility of these components in SC—CO₂ is extremely low. In an effort to increase the solubility of carotenoids in SC—CO₂, addition of organic solvents, such as ethanol, as a co-solvent into SC—CO₂ has been reported. However, this approach negates the major advantages of SC—CO₂ extraction technology since additional heat treatment is needed to remove ethanol from the final product. On the other hand, the use of SC—CO₂ alone eliminates any solvent residues in the final product, and the extraction can be carried out at just above ambient temperatures, minimizing any degradation of heat labile components.

WO2001/79355 by Shi, entitled “Separation of Carotenoids from Fruits and Vegetables” discloses a process wherein a powdered fruit or vegetable is mixed with a small amount of edible oil and then extracted with SC—CO₂. In this case, therefore, the oil is co-extracted with carotenoids, and once the oil is depleted its co-solvent effect will cease.

Similarly, the process described by Vasapollo, et al. (Journal of Supercritical Fluids, 29: 87-96) in their paper entitled “Innovative Supercritical CO₂ Extraction of Lycopene from Tomato in the Presence of Vegetable Oil as a Co-Solvent” is also based on a pre-mixing process where the tomato powder is mixed with hazelnut oil prior to SC—CO₂ extraction.

A carotenoid extraction and purification procedure that is capable of being used on an industrial scale and which avoids the use of organic solvents, but which results in a good yield of carotenoid, would be of substantial benefit in the food, feed, cosmetic and pharmaceutical industries.

### SUMMARY OF THE INVENTION

Described herein is a method for separating carotenoids from carotenoid-containing material and a carotenoid-containing composition made by the method.

In one aspect, described herein is a method for separating carotenoids from carotenoid-containing material comprising:

(a) sizing a carotenoid-containing material;

(b) passing a mixture of oil and supercritical CO₂ (SC—CO₂) continuously through the carotenoid-containing material at conditions effective to extract a carotenoid into the mixture of oil and SC—CO₂; and

(c) collecting the carotenoid-containing oil.

In yet another aspect, described herein is carotenoid-containing composition made by the method.

Disclosed herein is a process that uses SC—CO₂ and a co-solvent, in particular, a continuous co-solvent, for the extraction of natural carotenoids in high yield from carotenoid-containing materials, e.g., plant materials, such as carrots and tomatoes as well as marine algae. The process uses an oil, e.g., an edible oil, which can be a vegetable oil, for example, canola oil, as a co-solvent for the SC—CO₂ extraction of carotenoids from these natural materials. Since carotenoids are lipid-soluble components, addition of oil into SC—CO₂ enhances the solubility and recovery of carotenoids from plant materials.

In an example process of the invention, the oil can be mixed into SC—CO₂ and this mixture can be continuously passed through an extraction cell containing plant material, such as carrots or marine algae, to extract carotenoids. This process enhances the efficiency of extraction of carotenoids, as compared to known processes.

The product can be oil, such as canola oil, saturated with carotenoids, such that carotenoid crystals may separate out at the bottom of the product. Carotenoid-saturated oil made by the invention can be used as such in numerous food and non-food applications. The antioxidant activity of this oil can be similar to that of butylated hydroxy toluene (BHT), which is a highly potent synthetic antioxidant used extensively in food products.

Accordingly, one aspect of this invention includes a method for the separation of carotenoids from natural material, comprising the steps of:

(a) sizing a natural material;

(b) passing a mixture of oil and supercritical-CO₂ continuously through the sized natural material; and

(c) collecting the oil and carotenoids contained therein.

The sizing can be, for example, by grinding. In one embodiment of a method of the invention, after step (a) the ground plant material can be dried partially or completely to generate a powder, and the powder can be used in subsequent steps. Alternatively, the natural material can be dried before sizing it.

Additional advantages will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

FIG. 1 shows the extraction yield of crude carrot oil with traditional solvent extraction (TSE) and supercritical fluid extraction (SFE) without co-solvent addition.

FIG. 2 shows the total amount of oil collected with SC—CO₂ with canola oil addition as a co-solvent. The curves on the left are for 2.5% oil addition and the curves on the right are for 5% oil addition as co-solvent into SC—CO₂.

FIG. 3 shows the estimated response surface plots for the yield of total carotenoids (μg/g) as a function of extraction temperature and canola oil concentration at 41.3 MPa.

FIG. 4 shows the total oil collected at different particle sizes in Example 1 (with dry sample at temperature of 70° C., pressure of 55.1 MPa, canola oil addition of 5% level, and a SC—CO₂ flow rate of 1 L/min).

FIG. 5 shows the total carotenoids extracted at different particle sizes in Example 1 (at 50° C., 55.1 MPa, and 5% canola oil concentration).

FIG. 6 shows the total oil collected at different moisture levels in Example 1 (at a temperature of 70° C., pressure of 55.1 MPa, and canola oil addition of 5% level, and a SC—CO₂ flow rate of 1 L/min).

FIG. 7 shows the water extracted at different moisture levels of feed material in Example 1 (at a temperature of 70° C., pressure of 55.1 MPa, and canola oil addition of 5% level, and a SC—CO₂ flow rate of 1 L/min).

FIG. 8 shows the total carotenoids (μg/g feed) extracted at different moisture levels of feed material in Example 1 (with particle size of 0.25-0.5 mm at 70° C., 55.1 MPa, and 5% of canola oil addition).

FIG. 9 shows the amount of total carotenoids extracted at different CO₂ flow rates in Example 1 (at 70° C., 55.1 MPa and 5% canola oil addition with 0.25-0.5 mm dry carrot particles).

FIG. 10 shows antioxidant activity of extracts and fiber compared with that of BHT from Example 1.

FIG. 11 shows a schematic representation of one embodiment of a method of the invention.

### DETAILED DESCRIPTION

Before the present compounds, compositions, articles, devices, and/or methods are disclosed and described, it is to be understood that the aspects described below are not limited to the specific embodiments, as they may, of course, vary. It is also to be understood that the terminology used herein is for the purpose of describing particular aspects only and is not intended to be limiting.

In this specification and in the claims which follow, reference will be made to a number of terms which shall be defined to have the following meanings:

It must be noted that, as used in the specification and the appended claims, the singular forms “a,” “an,” and “the” include plural referents unless the context clearly dictates otherwise. Thus, for example, reference to “an oil” includes mixtures of oils; reference to “a carotenoid” includes mixtures of two or more such carotenoids, and the like.

“Optional” or “optionally” means that the subsequently described event or circumstance may or may not occur, and that the description includes instances where the event or circumstance occurs and instances where it does not. For example, the phrase “optionally drying the material” means that the material may or may not be dried and that the description includes both dried material and undried material.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

A. Compositions

In one aspect described herein are compositions, in particular, carotenoid-containing extracts, made by a method described below. A composition of the invention includes a carotenoid-saturated oil. A carotenoid-saturated oil of the invention will contain no organic solvents.

B. Methods

Disclosed herein is a method for extracting carotenoids from carotenoid-containing material, in particular, natural material such as plant material or marine algae. The method results in a high yield of carotenoids from a carotenoid-containing material.

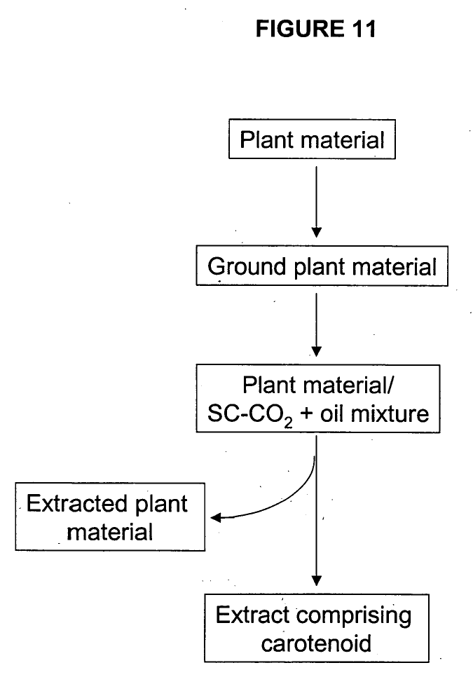

A schematic of a flow diagram of a method disclosed herein is shown in FIG. 11. The example method involves sizing, e.g., grinding, of the plant material (step 1), and optionally drying the material to some extent, for example, to generate a powder, continuous extraction of that powder with a mixture of edible oil and supercritical CO₂ (SC—CO₂) (step 2) and collection of the oil extract containing carotenoid crystals (step 3).

A variety of carotenoid-containing materials can be used, in particular a natural material. For example, a variety of plant materials can be used, including fruits or vegetables, or mixtures of fruits and vegetables. In one embodiment, a vegetable can be carrots. In another embodiment, a fruit can be tomatoes. In yet another embodiment, the natural material can be marine algae.

Many pigments of the carotenoid class have been identified in natural materials, including carotenes such as lycopene, α-carotene, β-carotene, γ-carotene, δ-carotene, phytoene, phytofluene, neurosporene, and their oxygenated derivatives such as lutein, zeaxanthin, astaxanthin, and others. In one embodiment, α- and β-carotene are extracted. In another embodiment, the carotenoid can be lutein. In yet another embodiment, the carotenoid can be lycopene.

The plant materials can be obtained from a variety of sources and can be used in whole or in part. For example, in one embodiment, only the skin and pericarp layers of tomatoes are used, whereas in another embodiment, the entire tomato can be used.

A first step of a method of the invention can be to reduce the particle size of the carotenoid-containing material. The carotenoid-containing, e.g., plant, material can first be mechanically reduced in size, for example, by cutting or chopping, by crushing, by blending, by homogenizing, by cooking, or by other similar methods. One of skill in the art can determine an appropriate method for reducing the size of the carotenoid-containing material. The carotenoid-containing material can then be freeze-dried, after which the freeze-dried material can be ground to a selected size and sieved prior to extraction. Non-limiting examples of suitable particle size distributions can be about 0.25-0.5 mm, about 0.5-1.0 mm, and about 1-2 mm. In one embodiment, the particle size can be less than about 0.25 mm. In another embodiment, the particle size can be between about 0.25-2 mm. In another embodiment, the particle size can be greater than about 2 mm. In other embodiments, the particle size can be about, for example, 0.1, 0.2, 0.3, 0.4, 0.5, 0.6, 0.7, 0.8, 0.9,1.1,1.2, 1.3, 1.4, 1.5,1.6,1.7,1.8, 1.9, 2.5, or 3 mm. The particle size can be a mixture of or distribution of sizes or the particles can be all of about the same size. Once the selected size is achieved, the ground samples can be vacuum packed in moisture and oxygen-barrier bags and stored at −18° C. in the dark, in order to minimize carotenoid degradation prior to extraction (if not immediately extracted).

The final particle size of the sized, e.g., ground, samples can be selected, in part, on the basis of the type of carotenoid being extracted and the type of carotenoid-containing material used. For most carotenoids and plant materials, the smaller the particle size, the better the yield. However, that may not always be the case. For example, for extraction of lutein from carrots, particle size effect appears to be negligible, whereas for extraction of α- and β-carotene, particle size significantly affected the yield. As is apparent to those of skill in the art, particle size can be a variable that is to be selected on a case-by-case basis, and the optimal particle size can be determined by routine experimentation, as demonstrated in the Examples herein.

The ground natural material can be dried somewhat, to remove water, before the continuous extraction procedure is started. The water can be removed from the plant material before it is sized, e.g., cut up, (i.e., whole), from the sized, e.g., cut up, plant material, or from the sized/dried, e.g., ground, plant material. As carotenoids are sensitive to heat and oxygen, freeze-drying can be a preferred method of removing water from the plant material sample. However, other methods of drying the material, such as air drying, can be used. One of skill in the art can determine an appropriate method for drying (or adjusting the moisture content of) the material.

The final water content of the ground plant material or algae can be selected, in part, on the basis of the type of carotenoid being extracted and the type of plant material or algae used. Water will be co-extracted with the carotenoids and will, therefore, likely be present in the oil extract if it is in the ground plant material. Therefore, if it is desired that the oil be free or substantially free of water, the water content of the ground plant material can be a consideration. For most carotenoids and plant materials, the lower the water content, the better the yield. However, that may not always be the case. For example, for extraction of lutein from carrots, yield increased with water content, whereas for extraction of α- and β-carotene, yield decreased with water content. In one embodiment, water content can be less than about 10% by weight; in another embodiment, water content can be less than about 1% by weight. In one embodiment, the ground plant material can be a powder that is substantially free of water. In another embodiment, the ground plant material can be a powder that is free of water. In other embodiments, the water content can be about, for example, 9, 8, 7, 6, 5, 4, 3, 2, 0.5, 0.4, 0.3, 0.2, or 0.1 wt %. As is apparent to those of skill in the art, water content can be a variable that is to be selected on a case-by-case basis, and the optimal water content of the ground plant material can be determined by routine experimentation, as demonstrated in the Examples herein.

It is to be understood that the number and type or nature of steps used to prepare the ground plant material and/or powder of the plant material or algae can be many and varied. Once the ground plant material and/or powder is prepared, it can be subjected to continuous extraction with an edible oil and SC—CO₂. Variables that affect yield include, for example, temperature, pressure, oil concentration, and CO₂ flow rate, as discussed below.

A variety of edible oils can be used in the method disclosed herein, including vegetable and fish oils. For example, the edible oil can be soybean oil, corn oil, olive oil, peanut oil, or mixture thereof. In one embodiment, the oil can be canola oil. The amount of oil, for example, can be between about 1% by weight and about 20% by weight of the amount of CO₂. In one embodiment, the amount of oil can be about 2.5% by weight of the amount of CO₂. In another embodiment, the amount of oil can be about 5% by weight of the amount of CO₂. In other embodiments, the amount of oil can be about, for example, 1.5, 2, 3, 4, 6, 8,10,12,14,16, or 18 wt% of the amount of CO₂.

The wt. % of oil used can be selected, in part, on the basis of the type of carotenoid being extracted and the type of plant material or algae used, as well as the solubility of oil in the SC—CO₂ under the conditions of extraction. For example, for extraction of lutein from carrots, the wt. % of oil affects yield. Yield of α- and β-carotene can also be affected by the wt. % of oil. As is apparent to those of skill in the art, wt. % of oil can be a variable that is to be selected on a case-by-case basis, and the optimal amount can be determined by routine experimentation, as demonstrated in the Examples herein.

Likewise, the temperature used during the continuous extraction can be selected, in part, on the basis of the type of carotenoid being extracted and the type of plant material or algae used. Temperature does not appear to have as great an effect on yield as do other variables such as wt. % oil. None-the-less, it can be a variable to be controlled. In one embodiment, the temperature can be about 70° C. In another embodiment, the temperature can be between about 35-100° C. In other embodiments, the temperature can be about, for example, 40, 45, 50, 55, 60, 65, 75, 80, 85, 90, or 95° C. As is apparent to those of skill in the art, temperature can be a variable that is to be selected on a case-by-case basis, and the optimal temperature can be determined by routine experimentation, as demonstrated in the Examples herein.

Theoretically, solubility of carotenoids increases with increasing pressure at a constant temperature. Pressure does not appear to have as great an effect on yield as do other variables such as wt. % oil. None-the-less, it can be a variable to be controlled. In one embodiment, the pressure can be about 55.1 MPa. In another embodiment, the pressure can be between about 10-100 MPa. In other embodiments, the pressure can be about, for example, 20, 30, 40, 45, 50, 57, 60, 65, 70, 80, or 90 MPa. As is apparent to those of skill in the art, pressure can be a variable that is to be selected on a case-by-case basis, and the optimal pressure can be determined by routine experimentation, as demonstrated in the Examples herein.

Generally, the amount of oil extracted increases with CO₂ flow rate. In one embodiment, the flow rate can be about 0.5 L/min, which is about 1 g/min, using the density conversion at ambient conditions. In another embodiment, the flow rate can be about 1.0 L/min measured at ambient conditions. In another embodiment, the flow rate can be about 3.0 L/min measured at ambient conditions. In large scale commercial plants, for example, the flow rate can be as high as about 20,000 g/min CO₂. In another embodiment, the flow rate can be between about 0.5-3.0 L/min. In other embodiments, the flow rate can be about, for example, 0.7, 0.9, 1.1, 1.2, 1.5, 1.7, 2.0, 2.4, 2.5, 2.8, or 2.9. As is apparent to those of skill in the art, CO₂ flow rate can be a variable that is to be selected on a case-by-case basis, and the optimal CO₂ flow rate can be determined by routine experimentation, as demonstrated in the Examples herein.

Equipment and methods for performing supercritical extraction of a material are known to one of skill in the art. An extraction method of the invention described here can be practiced by placing the plant material or algae powder into an extraction vessel, which will permit the edible oil and SC—CO₂ to flow continuously through the plant material. Metal filters and/or glass wool can be used to prevent sample carry over.

The desired extraction temperature can be achieved by heating the extraction vessel. CO₂ can be filtered and compressed to the desired pressure and extraction pressure can be controlled by a back pressure regulator. The flow rate of CO₂ passing through the extractor can be controlled by manual adjustment of a needle metering valve that is heated to prevent freezing upon depressurization of SC—CO₂. In pilot plant or commercial systems, the CO₂ can be recycled (without depressurizing all the way down to ambient conditions) with automatic control of flow rate. The edible oil can be introduced to the extraction system as a co-solvent by setting the flow rate of a piston pump to achieve the desired oil concentration.

The extraction can be performed for about 4 hours, or less, for example, if the flow rate is higher. During this time, fresh oil and CO₂ can be pumped continuously through the sample, so that this mixture contacts the sample only once as it flows through the cell. An additional 3 hours can be used to collect the remaining canola oil introduced during the original extraction period. During this time, supercritical CO₂ at high pressure and temperature can be passed through the sample. The oil can be collected in side-armed glass tubes attached after a depressurization valve. Larger pilot plant and commercial systems can use a separator vessel where the extract can be collected upon depressurization. Crystals of carotenoids can be present in the oil collected in the separator.

While the method has been described in conjunction with the disclosed embodiments, it will be understood that the invention is not intended to be limited to these embodiments. On the contrary, the invention is intended to cover alternatives, modifications and equivalents, which may be included within the spirit and scope of the invention as defined by the appended claims. Various modifications will remain readily apparent to those skilled in the art.

C. Utility and Administration

A composition of the invention can be used as a natural antioxidant with health benefits, especially in the rapidly growing functional food and nutraceutical market. A composition of the invention can, for example, have a substantial benefit in the food, feed, cosmetic, and pharmaceutical industries. One of skill in the art can determine appropriate end uses for a carotenoid-containing composition of the present invention.

### References

R. L. Mendes, B. P. Nobre, J. P. Coelho, A. F. Palavra, “Solubility of β-carotene in supercritical carbon dioxide and ethane,” J. Supercrit. Fluids, 16 (1999) 99.

Larrauri, J. L.; Goni, I.; Martin-Carron, N.; Ruperez, P.; Saura-Calixto, F. “Measurement of health-promoting properties in fruit dietary fibres: antioxidant capacity; fermentability and glucose retardation index,” J. Sci. Food Agric. (1996) 71, 515-519.

A. K. K. Lee, N. R. Bulley, M. Fattori, A. Meisen, “Modeling of supercritical carbon dioxide extraction of canola oilseed in fixed beds,” J. Am. Oil Chem. Soc. 63(7) (1986) 921.

F. Temelli, “Extraction of Triglycerides and phospholipids from canola with supercritical carbon dioxide and ethanol,” J. Food Sci. 57(2) (1992) 440-457.

### EXAMPLES

The following examples are put forth so as to provide those of ordinary skill in the art with a complete disclosure and description of how the compounds, compositions, articles, devices, and/or methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

### Example 1

### Method and Determination of Extraction Conditions

1. Methodology

1.1. Carrot Sample Preparation

Carrots (25 kg) were washed thoroughly with cold tap water and their surface was dried. The carrots were then chopped into 5 mm cubes and well mixed. A small portion of carrot cubes were retained for proximate composition analysis and the remaining portion was freeze dried. The desired particle size distribution (0.25-0.5 mm, 0.5-1 mm, and 1-2 mm) was achieved by grinding the cubes and sieving prior to extraction. The ground sample was vacuum packed in several moisture and O₂-barrier bags, labeled, and stored at −18° C. in the dark to minimize carotenoid degradation.

The moisture content of the carrot sample was modified by adding milli-Q water to dried carrot sample of particle size 0.25-0.5 mm, followed by overnight tempering at 4° C. prior to extraction. The actual moisture content of the sample prior to extraction (84.6%, 48.7%, and 17.5%) was determined according to standard methodology.

1.2. Traditional Solvent Extraction (TSE) of Carotenoids

Traditional solvent extraction of carotenoids was conducted according to Official Methods of Analysis of AOAC International, 941.15 (2000). Approximately 2 g of freeze-dried carrots was homogenized for 5 min at 70 rpm with 100 mL hexane/acetone (6:4 v/v) containing 0.005% (w/v) BHT. The sample was filtered in vacuo, and the residue was washed first with acetone (2×25 mL) and then with 25 mL of hexane. The combined organic filtrate was washed three times with 100 mL of milli-Q water. The organic phase was dried over nitrogen with gentle flow. The dried extraction residue was weighed and stored at −18° C. until analysis.

1.3. Supercritical Fluid Extraction

A laboratory scale Supercritical Fluid Extraction Screening System (Newport Scientific Inc., Jessup, Md.) was used in this study. Two grams of carrot sample (±0.1 g) were weighed and loaded into a stainless steel basket (15 cm×13 mm I.D.), the ends of which were fitted with two 10 μ m metallic filters to avoid any sample carry over. Two thin layers of glass wool were also put inside the ends of the basket to avoid sample carry over. The desired extraction temperature was achieved by heating the extraction vessel (300 mL, 300 SS) with two silicon fiberglass electrical resistance type heating tapes (100 W each), and the temperature was monitored by a thermocouple immersed at the center of the extractor and regulated by a controller. CO₂ was filtered and compressed to desired pressure by a diaphragm compressor. The extraction pressure was controlled by a back pressure regulator. The flow rate of CO₂ (measured at ambient conditions) passing through the extractor was controlled by manual adjustment of a needle metering valve, which was heated to prevent freezing upon depressurization of SC—CO₂. Canola oil was introduced to the extraction system as the co-solvent by setting the flow rate of a piston pump (Gilson 305, Gilson, Inc., Middleton, Wis.) at 0.065 and 0.131 mL/min to achieve the desired oil concentration in SC—CO₂ (w/w) of 2.5 and 5%, respectively.

The extractions were performed for 4 h, and the extracted oil was collected in side-armed glass tubes attached after the depressurization valve, which were held in a refrigerated circulating bath at −20° C. For the extractions with canola oil addition, the extraction was continued for an additional 3 h to remove the remaining canola oil that was introduced as co-solvent during the original 4 h extraction. Depressurized CO₂ was passed through a rotameter, and the volume of CO₂ used was recorded by a dry gas meter before venting to atmosphere. The collected oil was transferred into a pre-weighed glass vial by washing the collection tubes several times with hexane, which was then removed under gentle nitrogen flow. The extracted oil samples were weighed and stored at −18° C. until analysis.

To investigate the effects of various extraction conditions, including temperature, pressure, canola oil concentration, particle size, flow rate, and moisture content of the feed material, the experimental design consisted of four sections as follows:

1. The effects of temperature, pressure, and canola oil concentration on SC—CO₂ extraction of carotenoids were tested by a complete 33 factorial design. Six repetitions were performed at the central design point to estimate the reproducibility of the experimental results. The three levels of temperature were 40, 55, and 70° C., whereas those of pressure were 27.6, 41.3, and 55.1 MPa. The three levels of canola oil addition in SC—CO₂ were 0, 2.5, and 5% (w/w). For ease of operation of the experiments, the dried carrot was used as feed material. A particle size of 0.5-1 mm and a flow rate of 1 L/min were chosen because they were the middle point of levels tested for each parameter in later sections. The extracts were collected in one tube throughout the 4 h extraction and were analyzed using HPLC as described below.

2. The effect of particle size on SC—CO₂ extraction of carotenoids was tested using feed material of different particle size (0.25-0.5, 0.5-1, and 1-2 mm). Temperature and pressure were kept constant at 70° C. and 55.1 MPa, respectively, based on the results of Section 1. The level of canola oil addition as co-solvent was maintained at 5%. The extracts were collected in 8 fractions every 30 min until 4 h. Extractions for each particle size were carried out in duplicate.

3. The effect of moisture content (84.6%, 48.7%, and 17.5%) on the SC—CO₂ extraction of carotenoids was tested at 70° C., 55.1 MPa, and canola oil concentration of 5%. The particle size of feed material was 0.25-0.5 mm, and the flow rate was fixed at 1 L/min. Extractions for each moisture level were carried out in duplicate while extract fractions were collected every 30 min. After each tube was removed from the extraction unit, it was left under dark at room temperature for 30 min to remove the remaining CO₂. The total weight of the tube with extract was recorded, and the total extract weight was calculated. Anhydrous sodium sulphate was added to the extraction tube until the water in the extract was completely absorbed. Then, the oil extract was washed out into a pre-weighed vial with hexane, and the weight of oil extract was determined. The weight of the water extract was the weight of the total extract minus the weight of the oil extract.

4. The effect of CO₂ flow rate (0.5, 1, and 2 L/min) on the SC—CO₂ extraction of carotenoids was tested with dried carrot samples of particle size 0.25-0.5 mm at 70° C., 55.1 MPa, and canola oil concentration of 5%. Extraction for each flow rate level was carried out in duplicate while extract fractions were collected every 30 min.

1.4. Carotenoids Identification and Quantification

Carotenoids identification and quantification were performed by high-performance liquid chromatography (HPLC) analysis according to a modified method of Mendes et al. (1999), hereby incorporated by reference for its teaching of the HPLC analysis. HPLC analysis of carotenoids was performed using a Shimadzu chromatograph (Shimadzu Scientific Instruments, Inc., Columbia, Md.). A Supelcosil™ LC-18 column, 15 cm×4.6 cm, 5 μm (Supelco, Inc. Bellefonte, Pa.) was used to separate individual carotenoids at ambient temperature. Samples (50 μL) in methanol/dichloromethane (1:1 v/v) were injected by a Hewlett Packard 1050 autosampler. Methanol with 10% (v/v) acetonitrile was used as mobile phase. The mobile phase was delivered at a flow rate of 1 mL/min under isocratic conditions by Varian 9010 solvent delivery system (Varian Associates, Sugar Land, Tex.). The separated lutein, α-carotene, and β-carotene peaks were monitored by a UV detector (Model Spectromonitor II, Laboratory Data Control, Riviera Beach, Fla.) operated at 450 nm wavelength. β-Carotene and lutein standards were used for identification and quantification based on a calibration curve. Since it was not possible to obtain α-carotene standard, it was assumed that α-carotene has a similar response factor as β-carotene and the concentration of α-carotene in various samples were calculated based on the calibration curve of β-carotene.

1.5. Antioxidant Activity

The antioxidant activity of the fiber residue extract was determined along with those of crystal and oil sample by the ferric thiocyanate (FTC) method reported by Larrauri et al. (1996), hereby incorporated by reference for its teaching of antioxidant activity measurement by the FRC method. A mixture of 0.5 mL of a weighed sample in absolute ethanol, 0.5 mL of 2.51% linoleic acid in 99.5% ethanol, 1 mL of 0.05 M sodium phosphate buffer (pH 7.0), and 0.5 mL of distilled water was placed in a small vial with a screw cap, then shaken and placed in an oven at 40° C. in the dark. A control without any test sample extract was also used. To 0.1 mL of this solution was added 9.7 mL 75% ethanol and 0.1 mL 30% ammonium thiocyanate. Precisely 3 min after addition of 0.1 mL 0.02 M ferrous chloride in 3.5% hydrochloric acid to the reaction mixture, the absorbance of the sample was measured on a spectrophotometer (Model Spectronic 3000 array, Milton Roy Company, Rochester, N.Y.) against a reagent blank at 500 nm, every 24 h (t) until one day after the absorbance of the control reached maximum. The oxidation index (OI) and antioxidation activity (AA) were calculated as:
OI=100*(Absorbanceₜ/Absorbanceₜ₌₀)
AA=100−100*(Product oxidation indexₜ/Control oxidation indexₜ)

1.6. Statistical Analysis

The effects of temperature, pressure, and canola oil concentration on the carotenoid extraction yield were analyzed by STATGRAPHICS Plus Version 5 (Manugistics Inc., 2000). Analysis of variance of carotenoid yield was performed to test the main three effects (temperature, pressure, and canola oil concentration) and the two-way interactions between them. The multiple regression equation, the estimated response surface plot, and the optimum combination of extraction factors were reported for the carotenoid yield. The effects of particle size, flow rate, and feed material moisture content on carotenoid yield were analyzed by the General Linear Model procedure of SAS Statistical Software, Version 8 (SAS Institute Inc., 1999).

2. Results and Discussion

The β-carotene content was 8080 μg/100 g, and the α-carotene content was 6940 μg/100 g of fresh carrot.

2.1. Effects of Temperature, Pressure, and Canola Oil Concentration

Oil Yield

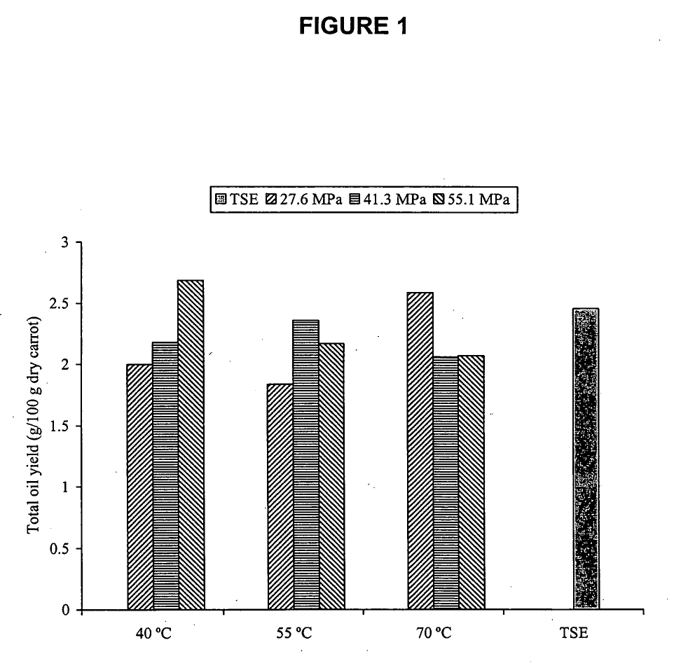

The yield of crude carrot oil extracted with TSE and SFE (SC—CO₂ without canola oil addition) under different combinations of temperature and pressure is presented in FIG. 1. The crude oil yields of SFE were 1.83-2.69 g/100 g dry carrot, which were similar to that obtained with TSE (2.46 g/100 g dry carrot). Theoretically, the solubility of carotenoids in SC—CO₂ increases with pressure at constant temperature. Because of the cross-over of solubility isotherms, in general, the solubility decreases with temperature at pressures below the cross-over pressure and increases with temperature at higher pressures. However, the values reported in FIG. 1 were the total amount of extract collected after 4 h, which may not correspond to solubility depending on the shape of the extraction curve, since it may have already reached the diffusion controlled region. The effect of temperature and pressure on the extraction yield was not significant (p>0.05).

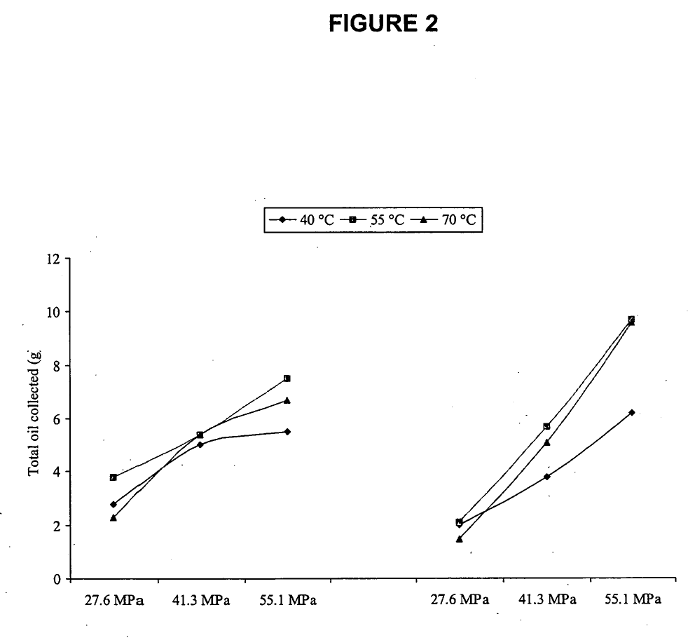

Compared with the amount of canola oil introduced into the system as a co-solvent (at CO₂ flow rate of 1 L/min, ca. 12 g canola oil was pumped into the system at 2.5% oil addition and ca. 24 g at 5% oil addition), the amount of crude oil in 2 g dry carrot is extremely small (approximately 0.04 g). Therefore, the total amount of oil collected in the separator tubes with SC—CO₂ with canola oil addition was mainly the canola oil added to the system as a co-solvent, plus a very small amount of carrot oil extracted from the feed material. However, it was not possible to separate the carrot oil from the canola oil added as co-solvent. The total amount of oil collected with canola oil addition at 2.5% level was 2.39 to 7.51 g, which was 43 to 153 times higher than that obtained without oil addition at corresponding temperature and pressure conditions, while the total amount of oil collected with canola oil addition at 5% level was 1.46 to 9.69 g, which was 29 to 217 times higher than that obtained without oil addition. The total amount of oil collected in 4 h increased with pressure at both levels of canola oil addition, and the increase became more substantial at higher temperatures and higher levels of canola oil addition (FIG. 2).

Carotenoids Yield

The α- and β-carotene contents of the starting material determined with TSE was 524.2 and 611.4 μg/g (dry matter basis), respectively. Lutein was not recovered by the TSE method. The extraction yield with SC—CO₂ without canola oil addition for α-carotene was 137.8-330.4 μg/g and β-carotene was 171.7-386.6 μg/g feed material at the different temperature and pressure conditions tested, which was approximately half of the amount determined by TSE. The extraction yield with SC—CO₂ plus canola oil for α-carotene was 287.96-846.68 μg/g and β-carotene was 333.76-899.97 μg/g feed material, which was more than double that obtained without canola oil addition. At the conditions of higher temperature, pressure and canola oil concentration, the yields of carotenes with SFE were even higher than that obtained with TSE. In addition, a substantial amount of lutein was extracted by the SFE method at all the conditions studied, which was not possible with TSE. The lutein yield with SFE was 23.5-37.5 μg/g and 55.05-178.99 μg/g feed material from extraction with canola oil addition. Analysis of the canola oil used as co-solvent showed no detectable level of carotenoids. These findings indicate that the use of canola oil as a co-solvent in SFE was very effective in increasing the carotenoids yield, substantially, for example, lutein extraction yield was increased by >4 times at certain extraction conditions with canola oil addition.

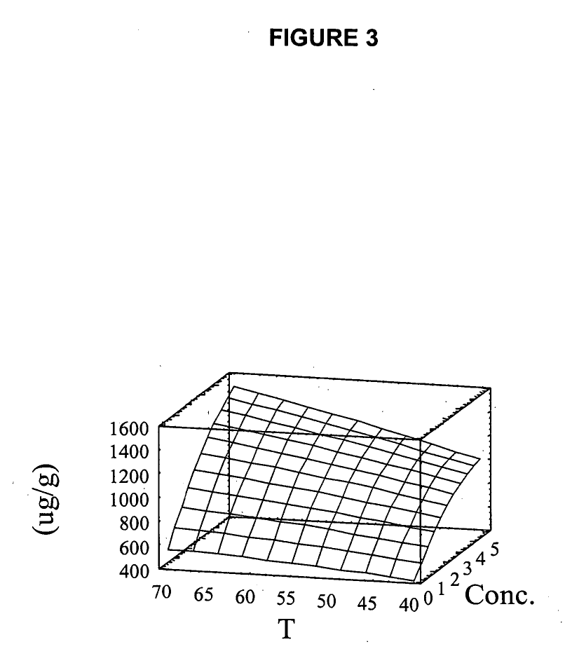

The two most significant effects of canola oil concentration and temperature on the yield of total carotenoids were demonstrated in the three-dimensional response surface plot in FIG. 3. The pattern and the slope of the lines, indicate that temperature did not have as significant an effect as canola oil concentration on the carotenoids yield. The yield increased with temperature at all concentration levels but this increase became more significant at higher oil concentrations. The optimum conditions for maximum yield of each and total carotenoids within the experimental region studied were 70° C., 55.1 MPa, and 5% canola oil addition.

2.2. Effect of Particle Size

The highest temperature (70° C.) and pressure (55.1 MPa) were proven to be the optimum temperature and pressure for the SC—CO₂ extraction of each individual and total carotenoids based on the first study, so these conditions were adopted in the study of the effect of particle size on the extraction yield of carotenoids. For α- and β-carotene, 5% was the optimum canola oil addition level, while for lutein, 3.7% was the optimum condition, therefore, 5% canola oil addition was used as α- and β-carotene were the predominant carotenoids in the extract.

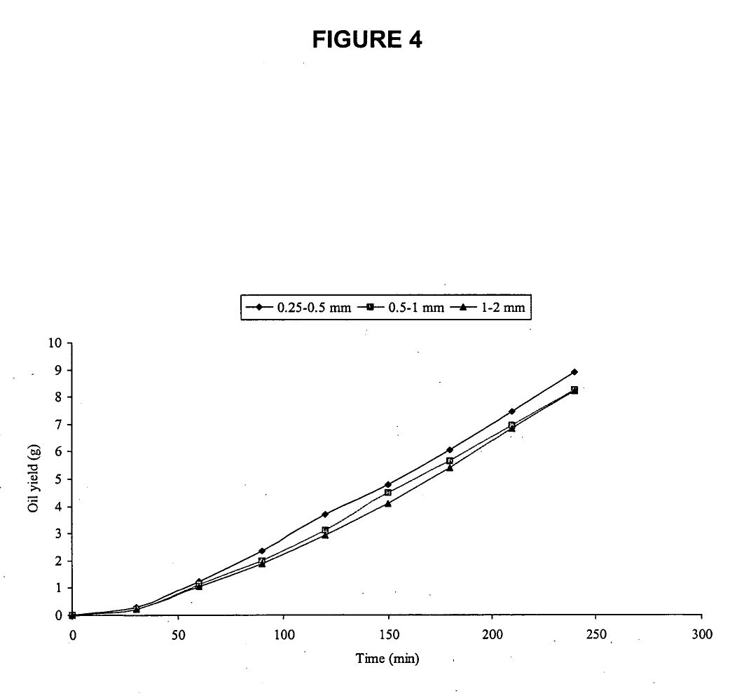

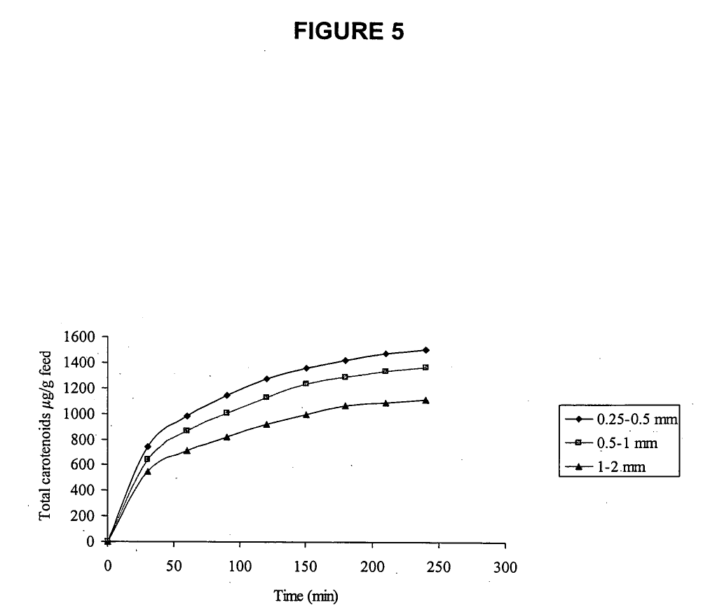

As shown in FIG. 4, the amount of oil collected was not affected significantly (p>0.05) with particle size. However, the carotenoids extracted were significantly (p<0.05) affected by particle size (FIG. 5). The effect of particle size on the α- and β-carotene yields was significant, whereas the particle size effect was not significant for lutein. As expected, these results indicate that the smaller the particle size, the higher the amount of carotenoids extracted. This phenomenon is supported by the theory of solute diffusion in particles; the longer the distance a solute has to travel from inside of the particle to the surface of the particle, the slower the extraction. If a long enough time were allowed for the extraction, all of the carotenoids in the carrot matrix could likely be extracted, eventually. Another important aspect is that there is a substantially larger contact surface between the extraction solvent and carotenoids when smaller particle size is used, which is especially important during the initial stages of extraction. From the fractions collected, it can be seen that most of the carotenoids was extracted during the first 30 min (FIG. 5). In the meantime, the total amount recovered in the first fraction was less than that of the other 7 fractions. Even though the canola oil started to be pumped into the extraction cell from the moment the extraction was started, it required some time for canola oil to saturate the carrot particles at a flow rate of 0.131 mL/min. Part of the added canola oil might be absorbed by the feed material while part of it was extracted with SC—CO₂, and the extraction efficiency was determined by the amount of oil in the cell as well as the solubility of the canola oil in SC—CO₂. As extraction progressed, there was more and more oil accumulated in the cell and the amount of oil collected in the separator was completely determined by the solubility of oil in SC—CO₂.

2.3. Effect of Moisture Content of Feed Material

Water represents approximately 80-90% of the total weight of plant material and interferes with the effectiveness of the SC—CO₂ extraction. Therefore, drying can be a necessary step prior to extraction. As carotenoids are sensitive to heat and oxygen, freeze-drying seems to be the preferred choice of drying carrot for the SC—CO₂ extraction of carotenoids. However, freeze-drying is another high cost processing on top of SFE. To minimize the additional drying cost prior to SFE, the optimal level of drying of the feed material should be determined.

As the smallest particle size (0.25-0.5 mm) was the optimum particle size in the previous study, this particle size was fixed in the study of effect of moisture content of feed material on the carotenoid yield with SC—CO₂ extraction. The optimum temperature (70° C.), pressure (55.1 MPa), and canola oil concentration (5%) were used.

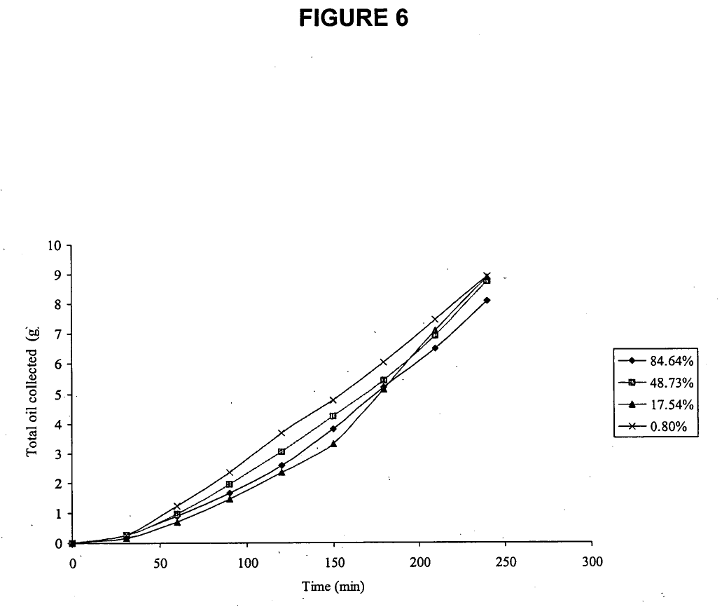

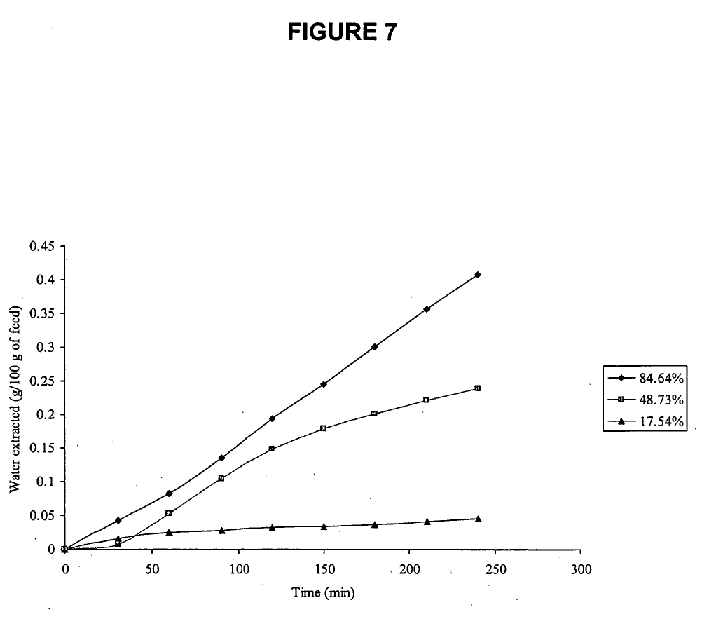

The moisture content of feed material had no significant (p>0.05) effect on the amount of total oil extracted (FIG. 6), even though the extract amount was slightly higher for dry feed material. However, the amount of water collected in the extract was significantly affected (p<0.0001) by the moisture content of the feed material (FIG. 7). The higher the amount of water in the feed material, the higher the amount of water co-extracted with oil and carotenoids.

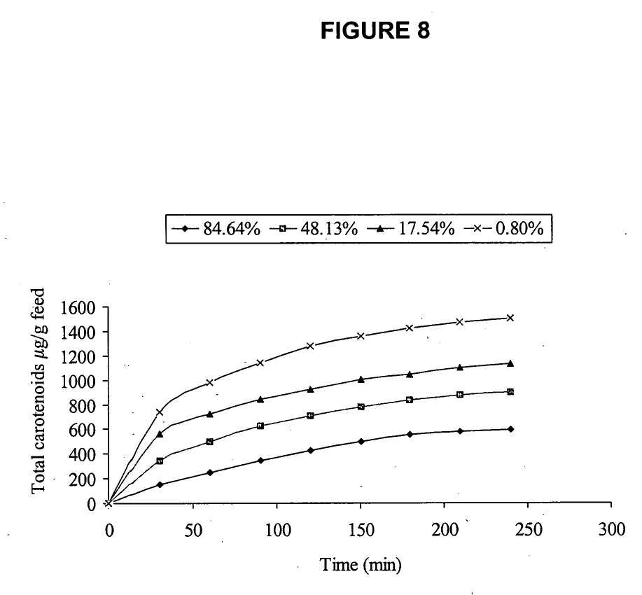

The moisture content of the starting material significantly affected the carotenoids yield (p<0.0001 for all the individual carotenoids) (FIG. 8). The α- and β-carotene yield decreased with moisture, while lutein yield increased with moisture (FIG. 8). This can be explained by the fact that moisture can act as a co-solvent for the extraction of a relatively polar compound such as lutein, whereas the presence of moisture is not favorable for the relatively non-polar carotenes.

2.4. Effect of CO₂ Flow Rate

Dry carrot particle was used in this section, since dried carrot was proven to give the highest carotenoids yield in previous studies. Other optimum extraction conditions, including temperature of 70° C., pressure of 55.1 MPa, canola oil addition at 5% level, and particle size of 0.25-0.5 mm were still used here. According to the previous runs, the flow rate at 1 L/min is low enough to allow the solute to reach its equilibrium solubility in SC—CO₂. However, to ensure saturation, a lowerflow rate of 0.5 L/min was used.

The total amount of oil collected increased with flow rate. At higher CO₂ flow rates, a larger amount of CO₂ is contacting the sample at any given time and, thus, a larger amount of oil is brought out of the system. However, when the amount of oil collected per kg CO₂ is evaluated, it is seen that the loading of CO₂ is higher at lower flow rates approaching the solubility limit (28.2 mg/kg CO₂) at 0.5 L/min. The canola oil loading of CO₂ at flow rate of 1 L/min was 23.1 mg/kg CO₂ and at flow rate of 2 L/min was 17.9 g/kg. The solubility value of canola oil in CO₂ from this study, 28.2 mg/kg, was between those reported by Lee et al. (1986) and Temelli (1992), which were 11 and 43.3 mg/kg, respectively.

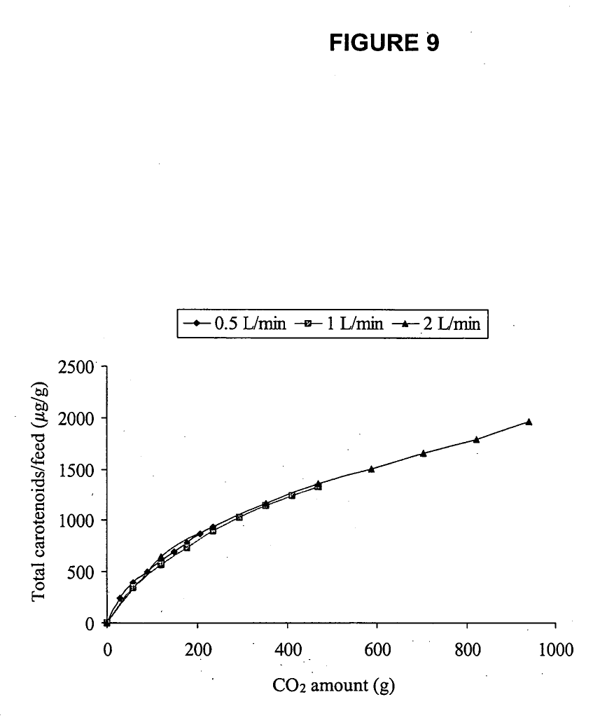

High carotenoids yield was obtained at high flow rate at the end of 4 h extraction period (FIG. 9). As the flow rate was increased, the extracted amount also increased, since more carotenoids were solubilized with more fresh solvent. However, with a further increase in flow rate, the contact time between the carotenoids and the solvent becomes shorter and the solvent may leave the system without dissolving all the solute it can actually solubilize. In otherwords, the carotenoids may not reach their maximum solubility before the solvent leaves the system. At a flow rate of 0.5 and 1 L/min, β-carotene and lutein can reach their equilibrium solubility, while at 2 L/min, the loading decreased. The overlap of the extraction curves for total carotenoids at different solvent flow rates indicate that equilibrium solubility limit was achieved. Therefore, the slope of the linear portion of the extraction curve at the low flow rate was calculated as the solubility of the carotenoids in SC—CO₂ plus canola oil. The solubility of the total carotenoids was 5.96 μg/ kg CO₂, and those for α-carotene, β-carotene, and lutein were 3.03, 2.65, and 0.128 μg/kg CO₂, respectively.

2.5. Antioxidant Activity of Oil Extract

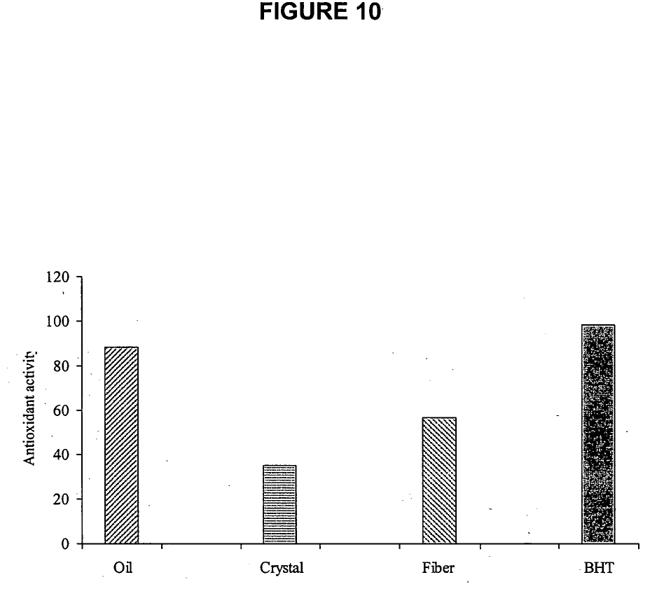

The total weight of the carotenoid crystals from ten extractions was 2.02 g, and the total oil saturated with carotenoids was 248.99 g. The α-carotene and β-carotene concentrations in the crystals were 54.7 and 159.71 mg/g, and those in the oil were 7.44 and 10.26 mg/mL, respectively. The antioxidant activity of the carotenoid crystals and the oil saturated with carotenoids was demonstrated in FIG. 10 together with that of the fiber residue, again compared with that of BHT. The concentration of BHT and crystallized carotenoids were 0.5 g/L and that of the oil saturated with carotenoids was 0.2 mL/L as used in the antioxidant test. It can be seen from the figure that the antioxidant activity of the carotenoid crystal (34.96) was approximately one-third of that of BHT. However, the antioxidant activity of the oil saturated with carotenoids (88.61) was only slightly lower than that of BHT (98.6). The difference in antioxidant activity may be due to the difference in the actual carotenoids content of these products.

Throughout this application, various publications are referenced. The disclosures of these publications in their entireties are hereby incorporated by reference into this application in order to more fully describe the compounds, compositions and methods described herein.

Various modifications and variations can be made to the compounds, compositions and methods described herein. Other aspects of the compounds, compositions and methods described herein will be apparent from consideration of the specification and practice of the compounds, compositions and methods disclosed herein. It is intended that the specification and examples be considered as exemplary.

1. A method for separating carotenoids from carotenoid-containing material comprising:
(a) sizing a carotenoid-containing material;
(b) passing a mixture of oil and supercritical CO₂ (SC—CO₂) continuously through the carotenoid-containing material at conditions effective to extract a carotenoid into the mixture of oil and SC—CO₂; and
(c) collecting the carotenoid-containing oil.

2. The method of claim 1 wherein the carotenoid-containing oil is collected by removing the CO₂.

3. The method of claim 2 wherein the removal of CO₂ is by bringing the conditions of the extract below CO₂ critical temperature and pressure.

4. The method of claim 1 wherein the sizing is grinding.

5. The method of claim 1 wherein the sizing is done to create a particle size of about 0.25—about 2 mm.

6. The method of claim 1 wherein the sizing is done to create a particle size of about 0.25—about 0.5 mm.

7. The method of claim 1 wherein the carotenoid-containing material is a natural material.

8. The method of claim 1 wherein the carotenoid-containing material is a fruit, vegetable, or mixtures thereof.

9. The method of claim 1 wherein the carotenoid-containing material is carrot or tomato.

10. The method of claim 1 wherein the carotenoid-containing material is marine algae.

11. The method of claim 1 further comprising drying the sized carotenoid-containing material.

12. The method of claim 11 wherein the dried sized material is a powder.

13. The method of claim 1 wherein the conditions effective to extract include a temperature of about 35—about 100° C.

14. The method of claim 1 wherein the conditions effective to extract include a temperature of about 70° C.

15. The method of claim 1 wherein the conditions effective to extract include a pressure of about 10—about 100 MPa.

16. The method of claim 1 wherein the conditions effective to extract include a pressure of about 55.1 MPa.

17. The method of claim 1 wherein the conditions effective to extract include a moisture content of less than about 10% by weight.

18. The method of claim 1 wherein the conditions effective to extract include a moisture content of less than about 1% by weight.

19. The method of claim 1 wherein the conditions effective to extract include a oil percentage of about 1—about 20% by weight of the amount of CO₂.

20. The method of claim 1 wherein the conditions effective to extract include a oil percentage of about 2.5—about 5% by weight of the amount of CO₂.

21. The method of claim 1 wherein the conditions effective to extract include a period of contact time sufficient to extract the carotenoids.

22. The method of claim 1 wherein the conditions effective to extract include a SC—CO₂ flow rate of about 0.5—about 3.0 L/min.

23. The method of claim 1 wherein the conditions effective to extract include a SC—CO₂ flow rate of about 1.0 L/min.

24. A composition made by the method of claim 1.

25. A carotenoid-containing oil extract comprising an edible oil saturated with a carotenoid wherein the extract is free of organic solvent.

26. A carotenoid-containing oil extract comprising an edible oil containing about 2 or greater times the amount of carotenoid achieved from a conventional extraction method.
